(19) United States
(12) Patent Application Publication
(10) Pub. No.: US 2006/0281653 A1
(43) Pub. Date: Dec. 14, 2006

(54) Compositions for removing cooked-, baked- and burnt-on soils

(75) Inventors: Howard David Hutton, Oregonia, OH (US); Peter Robert Foley, Cincinnati, OH (US); Kevin George Goodall, Tervuren (BE)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company

(21) Appl. No.: 11/012,957

(22) Filed: Dec. 15, 2004

Related U.S. Application Data
(60) Provisional application No. 60/529,504, filed on Dec. 15, 2003.

(51) Int. Cl. C11D 1/94

(52) U.S. Cl. 510/237

(57) ABSTRACT

The present invention relates to a composition for use in hand dishwashing that is particularly effective in the removal of cooked-, baked-, or burnt-on food residue soils. The composition comprises a soil swelling agent, a soil modifying agent and an enzyme.

### CROSS REFERENCE TO RELATED APPLICATION

This application claims the benefit of U.S. Provisional Application No. 60/529,504 filed on Dec. 15, 2003, the disclosure of which is incorporated by reference herein.

### TECHNICAL FIELD

The present invention relates to composition, especially hand dishwashing compositions comprising soil modifying agent, soil swelling agent and an enzyme. The compositions of the present invention are particularly useful in the removal of polymerised, baked-on, greasy soils from cookware, tableware and kitchen surfaces.

### BACKGROUND TO THE INVENTION

Cooked-, baked- and burnt-on soils are amongst the most severe types of soils to remove from surfaces. Traditionally, the removal of cooked-, baked- and burnt-on soils from cookware and tableware requires soaking the soiled object prior to a mechanical action. Manual dishwashing process requires a tremendous rubbing effort to remove cooked-, baked- and burnt-on soils and this can be detrimental to the safety and condition of the cookware/tableware. Generally all cooked-, baked- and burnt-on soils are difficult to remove, however of particular relevance herein are the grease-based soils, especially polymerised grease soils and protein-based soils.

The use of cleaning compositions in the removal of cooked-, baked- and burnt-on solids is known in the art. For example, U.S. Pat. No. 5,102,573 provides a method for treating hard surfaces soiled with cooked-on, baked-on or dried-on food residues, comprising applying a pre-spotting composition to the soiled article. The composition applied comprises surfactant, builder, amine, and solvent and have a pH of around 10. U.S. Pat. No. 5,929,007 provides an aqueous hard surface cleaning composition for removing hardened dried or baked-on grease soil deposits. The composition comprises nonionic surfactant, chelating agent, caustic, a glycol ether solvent system, organic amine and anti-redeposition agents, and has high pH of 11.5 or higher.

The compositions described above do have some efficacy in the removal of grease-based soils, they are not effective in the removal of protein-based soils. Moreover the chemical composition of the cleaning compositions described can have an adverse effect on the surfaces treated. Metal surfaces such as aluminum are easily oxidized by the high pH of the composition causing the surface to before pitted and discoloured. Moreover, the high pH of the composition can hydrolyse bonds in many paints or enamels which are used to decorate tableware. Hydrolysis causes discolouration of the paintwork, and may even result in removal of less surface-substantive enamels.

It is therefore an object of the present invention to provide a composition suitable for cleaning cooked-, baked- and burnt-on soils, which has improved efficacy on greasy soils, especially polymerized grease and protein-based soils and which is comparatively less aggressive to skin and surfaces alike.

### SUMMARY OF THE INVENTION

According to the present invention there is provided a composition suitable for cleaning cooked-, baked- and burnt-on soils having a pH of a 10% solution thereof of from 6 to 10 and comprising a surface modifying agent selected from the group consisting of alkyl esters having the formula RCOOR₁, wherein the R group is selected from the group consisting of C1-C6 alkyl and the R₁ group is selected from the group consisting of C4-C40 fatty acid, a soil swelling agent and an enzyme.

### DETAILED DESCRIPTION OF THE INVENTION

The compositions of the present invention may be in the form of liquids, gels or pastes and may exist as homogeneous compositions, microemulsions or emulsions. Where the composition is an emulsion, it is preferred that in use, the user shake the container comprising the composition in order to mix the phases of the emulsion before dispensing.

Soil Swelling Agents

A soil swelling agent is a substance or composition effective in swelling cooked-, baked- and burnt-on soils as disclosed above. Preferred soil swelling agents for use herein include organoamine solvents Preferably the soil swelling agent is not present in the form of a surfactant salt. The Applicants have found that whilst surfactant salts of the soil swelling agent perform well in the removal of grease, they do not perform as well as free or inorganic salts thereof. By ‘free’ it is meant the non-protonated, neutral form of the molecule. By ‘inorganic salts’ it is meant small anion salts such as chlorides, bromides, phosphates, etc. Whilst not wishing to be bound by theory it is believed that this is due to the fact that large molecular weight organic surfactant salts of the soil swelling agent do not penetrate into the soil as efficiently as free or inorganic salts. Hence as the larger salts are slower to penetrate the soil, they are consequently less effective at swelling the soil.

Most preferred soil swelling agents are selected from alkanolamines, especially monoethanolamine, beta-aminoalkanols, especially 2-amine-2 methyl-propanol (since it has the lowest molecular weight of any beta-aminoalkanol which has the amine group attached to a tertiary carbon, therefore minimize the reactivity of the amine group) and mixtures thereof.

The soil swelling index (SSI) is a measure of the increased thickness of soil after treatment with a substance or composition in comparison to the soil before treatment with the substance or composition. It is believed, while not being limited by theory that the thickening is caused, at least in part, by hydration or solvation of the soil. Swelling of the soil makes the soil easier to remove with no or minimal application of force, e.g. wiping, rinsing or manual and automatic dishwashing. The measuring of this change of soil thickness gives the SSI.

The amount of substance or composition necessary to provide soil swelling functionality will depend upon the nature of the substance or composition and can be determined by routine experimentation. Other conditions effective for soil swelling such as pH, temperature and treatment time can also be determined by routine experimentation. Preferred herein, however are substances and compositions effective in swelling cooked-, baked- or burnt-on soils such as polymerized grease or carbohydrate soils on glass or metal substrates, whereby after the substance or composition has been in contact with the soil for 45 minutes or less, preferably 30 min or less and more preferably 20 min or less at 20° C., the substance or composition has an SSI at 5% aqueous solution and pH of 9 of at least about 15%, preferably at least about 20% more preferably at least about 30% and especially at least about 50%. Preferably also the choice of soil swelling agent is such that the final compositions have an SSI measured as neat liquids under the same treatment time and temperature conditions of at least about 100%, preferably at least about 200% and more preferably at least about 500%. Highly preferred soil swelling agents and final compositions herein meet the SSI requirements on polymerized grease soils according to the procedure set out below.

SSI is determined herein by optical profilometry, using, for example, a Zygo NewView 5030 Scanning White Light Interferometer®. A sample of polymerized grease on a brushed, stainless steel coupon is prepared as described herein below with regard to the measurement of polymerized grease removal index. Optical profilometry is then run on a small droplet of approximately 10 μm thickness of the grease at the edge of the grease sample. The thickness of the soil droplet before (Sᵢ) and after (S_{f}) treatment is measured by image acquisition by means of scanning white light interferometry. The interferometer (Zygo NewView 5030® with 20× Mirau objective) splits incoming light into a beam that goes to an internal reference surface and a beam that goes to the sample. After reflection, the beams recombine inside the interferometer, undergo constructive and destructive interference, and produce a light and dark fringe pattern. The data are recorded using a CCD (charged coupled device) camera and processed by the software of the interferometer using Frequency Domain Analysis. The dimension of the image obtained (in pixels) is then converted in real dimension (μm or mm). After the thickness of the soil (Sᵢ) on the coupon has been measured the coupon is soaked in the invention composition at ambient temperature for a given length of time and the thickness of the soil (S_{f}) is measured repeating the procedure set out above. If necessary, the procedure is replicated over a sufficient member of droplets and samples to provide statistical significance.

The SSI is calculated in the following manner:
SSI=[(S_{f}−Sᵢ)/Sᵢ]×100

In a preferred embodiment herein, the compositions herein may comprise from 0.01% up to about 10%, preferably of from about 2% to about 8%, more preferably of from about 3% to about 7% and most preferably of from about 4% to about 6% by weight of the total composition of a soil swelling agent.

Soil Modifying Agents

The compositions herein also comprise a soil modifying agent selected from the group consisting of alkyl esters having the formula RCOOR₁, wherein the R group is selected from the group consisting of C1-C6 alkyl moieties, including linear, branched, cyclic including aryl, saturated, unsaturated moieties and mixtures thereof. More preferably the R group is selected from C1-C3 alkyl moieties. The R₁ group is selected from the group consisting of C4-C40 alkyl moieties, including linear, branched, cyclic including aryl, saturated, unsaturated moieties and mixtures thereof. More preferably said R1 group is selected from C6-C22 alkyl moieties. In the most preferred embodiments the alkyl ester is a methyl or ethyl ester of C6-C12 fatty acid or mixtures thereof.

The function of the surface modifying agent is to aid the wetting, penetration and softening of the soil via the reduction of the interfacial tension between the soil swelling agent and the soil, thereby increasing the wettability of the soil by the soil swelling agents. The surface modifying agent when added to the compositions herein containing soil swelling agents leads to a lowering in the surface tension of the compositions. It has been found that a surface modifying agent, when present, further improves the performance of the removal of cooked-, baked- and burnt-on soils of the compositions according to the present invention. Especially useful are surface modifying agent able to render a surface tension below about 35 mN/m, preferably below about 30 mN/m and more preferably below about 28 mN/m, and especially below about 27.5 mN/m and a pH, as measured in a 10% solution in distilled water. Surface tensions are measured herein at 25° C.

The soil modifying agent is preferably present in the composition at from 1% to 50% by weight of the composition, more preferably from 10% to 30% and most preferably from 20% to 30%.

Neither the soil swelling agent alone, enzyme alone nor the surface modifying agent alone will provide effective soil removal. Without wishing to be bound by the theory, it is believed that the soil swelling agent/enzyme and surface modifying agent act together to synergistically improve the grease and protein removal performance of the composition. Again whilst not wishing to be bound by theory it is believed that the surface modifying agent facilitates the interfacial process between the soil swelling agent or enzyme and the soil, aiding wetting, penetration and softening of the soil. The soil swelling agent, by turn, penetrates, hydrates and swells the soils. The soil penetration and swelling is believed to weaken the binding forces between soil and substrate. The resulting compositions are particularly effective in removing soils from metallic substrates.

Enzymes

The compositions of the present invention also comprise an enzyme. Said enzymes include enzymes selected from cellulases, hemicellulases, peroxidases, proteases, gluco-amylases, amylases, lipases, cutinases, pectinases, xylanases, reductases, oxidases, phenoloxidases, lipoxygenases, ligninases, pullulanases, tannases, pentosanases, malanases, β-glucanases, arabinosidases and mixtures thereof. A preferred combination is a detergent composition having a cocktail of conventional applicable enzymes like protease, amylase, lipase, cutinase and/or cellulase. Enzymes when present in the compositions, at from about 0.0001% to about 5% of active enzyme by weight of the detergent composition. Preferred proteolytic enzymes, then, are selected from the group consisting of Alcalase® (Novo Industri A/S), BPN′, Protease A and Protease B (Genencor), and mixtures thereof. Protease B is most preferred. Preferred amylase enzymes include TERMAMYL®, DURAMYL® and the amylase enzymes those described in WO 9418314 to Genencor International and WO 9402597 to Novo.

pH

It has been found that whilst previous compositions suitable for removing such cooked-, baked- and burnt-on soils required high pH in excess of 12.0 to provide the benefits, the present composition is improved in that it does not require such high pH to maintain efficacy. It is therefore a further embodiment of the present invention that the pH of a 10% solution of the composition can be lowered in the region of from 6 to 10, preferably 8 to 9.5. In addition the lower pH also means that the composition is less aggressive to skin and surfaces.

Surfactants

As an optional ingredient, the compositions here in additionally comprise a surfactant in addition to the surfactants used as wetting agents as described above, when present. The addition of surfactant selected from, anionic, amphoteric, zwitterionic, nonionic and semi-polar surfactants and mixtures thereof, to the composition of the invention aids the cleaning process and also helps to care for the skin of the user. Preferably the level of surfactant is from about 0.05 to about 10%, more preferably from about 0.09 to about 5% and more preferably from 0.1 to 2%. Preferred surfactants for use herein are sugar based nonionics including fatty glucose amides and fatty glucose esters.

In the compositions herein the surfactant is preferably foamable in direct application. Surfactants suitable herein include; anionic surfactants such as alkyl sulfates, alkyl ether sulfates, alkyl benzene sulfonates, alkyl glyceryl sulfonates, alkyl and alkenyl sulphonates, alkyl ethoxy carboxylates, N-acyl sarcosinates, N-acyl taurates and alkyl succinates and sulfosuccinates, wherein the alkyl, alkenyl or acyl moiety is C₅-C₂₀, preferably C₁₀-C₁₈ linear or branched; cationic surfactants such as chlorine esters (U.S. Pat. No. 4,228,042, U.S. Pat. No. 4,239,660 and U.S. Pat. No. 4,260,529) and mono C₆-C₁₆ N-alkyl or alkenyl ammonium surfactants wherein the remaining N positions are substituted by methyl, hydroxyethyl or hydroxypropyl groups; low and high cloud point nonionic surfactants and mixtures thereof including nonionic alkoxylated surfactants (especially ethoxylates derived from C₆-C₁₈ primary alcohols), ethoxylated-propoxylated alcohols (e.g., Olin Corporation's Poly-Tergent® SLF18), epoxy-capped poly(oxyalkylated) alcohols (e.g., Olin Corporation's Poly-Tergent® SLF18B—see WO-A-94/22800), ether-capped poly(oxyalkylated) alcohol surfactants, and block polyoxyethylene-polyoxypropylene polymeric compounds such as PLURONIC®, REVERSED PLURONIC®, and TETRONIC® by the BASF-Wyandotte Corp., Wyandotte, Mich. and alkylpolyglycosides; amphoteric surfactants such as the C₁₂-C₂₀ alkyl amine oxides (preferred amine oxides for use herein include lauryldimethyl amine oxide and hexadecyl dimethyl amine oxide), and alkyl amphocarboxylic surfactants such as Miranol™ C2M; and zwitterionic surfactants such as the betaines and sultaines; and mixtures thereof. Surfactants suitable herein are disclosed, for example, in U.S. Pat. No. 3,929,678, U.S. Pat. No. 4,259,217, EP-A-0414 549, WO-A-93/08876 and WO-A-93/08874.

Preferred alkylpolyglycosides have the formula
R²O(CₙH₂ₙO)ₜ(glycosyl)ₓ
wherein R² is selected from the group consisting of alkyl, alkyl-phenyl, hydroxyalkyl, hydroxyalkylphenyl, and mixtures thereof in which the alkyl groups contain from about 10 to about 18, preferably from about 12 to about 14, carbon atoms; n is 2 or 3, preferably 2; t is from 0 to about 10, preferably 0; and x is from about 1.3 to about 10, preferably from about 1.3 to about 3, most preferably from about 1.3 to about 2.7. The glycosyl is preferably derived from glucose. To prepare these compounds, the alcohol or alkylpolyethoxy alcohol is formed first and then reacted with glucose, or a source of glucose, to form the glucoside (attachment at the 1-position). The additional glycosyl units can then be attached between their 1-position and the preceding glycosyl units 2-, 3-, 4- and/or 6-position, preferably predominantly the 2-position.

Furthermore, the compositions herein may comprise a low cloud point non-ionic surfactant and suds suppresser.

The suds suppressers suitable for use herein include nonionic surfactants having a low cloud point. “Cloud point”, as used herein, is a well known property of nonionic surfactants which is the result of the surfactant becoming less soluble with increasing temperature, the temperature at which the appearance of a second phase is observable is referred to as the “cloud point” (See Kirk Othmer, pp. 360-362). As used herein, a “low cloud point” nonionic surfactant is defined as a nonionic surfactant system ingredient having a cloud point of less than 30° C., preferably less than about 20° C., and even more preferably less than about 10° C., and most preferably less than about 7.5° C. Typical low cloud point nonionic surfactants include nonionic alkoxylated surfactants, especially ethoxylates derived from primary alcohol, and polyoxypropylene/polyoxyethylene/polyoxypropylene (PO/EO/PO) reverse block polymers. In addition, such low cloud point nonionic surfactants include, for example, ethoxylated-propoxylated alcohol (e.g., Olin Corporation's Poly-Tergent® SLF18) and epoxy-capped poly(oxyalkylated) alcohols (e.g., Olin Corporation's Poly-Tergent® SLF18B series of nonionics, as described, for example, in U.S. Pat. No. 5,576,281).

Preferred low cloud point surfactants are the ether-capped poly(oxyalkylated) suds suppresser having the formula: 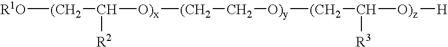
wherein R¹ is a linear, alkyl hydrocarbon having an average of from about 7 to about 12 carbon atoms, R² is a linear, alkyl hydrocarbon of about 1 to about 4 carbon atoms, R³ is a linear, alkyl hydrocarbon of about 1 to about 4 carbon atoms, x is an integer of about 1 to about 6, y is an integer of about 4 to about 15, and z is an integer of about 4 to about 25.

Other low cloud point nonionic surfactants are the ether-capped poly(oxyalkylated) having the formula:
R_{I}O(R_{II}O)ₙCH(CH₃)OR_{III}
wherein, R_{I} is selected from the group consisting of linear or branched, saturated or unsaturated, substituted or unsubstituted, aliphatic or aromatic hydrocarbon radicals having from about 7 to about 12 carbon atoms; R_{II} may be the same or different, and is independently selected from the group consisting of branched or linear C₂ to C₇ alkylene in any given molecule; n is a number from 1 to about 30; and R_{III} is selected from the group consisting of:
(i) a 4 to 8 membered substituted, or unsubstituted heterocyclic ring containing from 1 to 3 hetero atoms; and
(ii) linear or branched, saturated or unsaturated, substituted or unsubstituted, cyclic or acyclic, aliphatic or aromatic hydrocarbon radicals having from about 1 to about 30 carbon atoms;
(b) provided that when R² is (ii) then either: (A) at least one of R¹ is other than C₂ to C₃ alkylene; or (B) R² has from 6 to 30 carbon atoms, and with the further proviso that when R² has from 8 to 18 carbon atoms, R is other than C₁ to C₅ alkyl.

Surfactants are typically present at a level of from about 0.2% to about 30% by weight, more preferably from about 0.5% to about 10% by weight, most preferably from about 1% to about 5% by weight of composition. Preferred surfactants for use herein are low foaming and include low cloud point nonionic surfactants and mixtures of higher foaming surfactants with low cloud point nonionic surfactants, which act as suds suppresser therefore.

Builder

As another optional ingredient, the compositions herein may comprise a builder. Builders suitable for use in cleaning compositions herein include water-soluble builders such as citrates, carbonates and polyphosphates e.g. sodium tripolyphosphate and sodium tripolyphosphate hexahydrate, potassium tripolyphosphate and mixed sodium and potassium tripolyphosphate salts; and partially water-soluble or insoluble builders such as crystalline layered silicates (EP-A-0164514 and EP-A-0293640) and aluminosilicates inclusive of Zeolites A, B, P, X, HS and MAP. The builder is typically present at a level of from about 1% to about 80% by weight, preferably from about 10% to about 70% by weight, most preferably from about 20% to about 60% by weight of composition.

Preferably compositions for use herein comprise silicate in order to prevent damage to aluminium and some painted surfaces. Amorphous sodium silicates having an SiO₂:Na₂O ratio of from 1.8 to 3.0, preferably from 1.8 to 2.4, most preferably 2.0 can also be used herein although highly preferred from the viewpoint of long term storage stability are compositions containing less than about 22%, preferably less than about 15% total (amorphous and crystalline) silicate.

Thickening Agents

The compositions of the present invention also preferably meet certain rheological and other performance parameter including both the ability to be sprayed and the ability to cling to surfaces. For example, it is desirable that the product sprayed on a vertical stainless steel surface has a flow velocity less than about 1 cm/s, preferably less than about 0.1 cm/s. For this purpose, the product is in the form of a shear thinning fluid having a shear index n (Herschel-Bulkey model) of from about 0 to about 0.8, preferably from about 0.3 to about 0.7, more preferably from about 0.4 to about 0.6. Highly preferred are shear thinning liquids having a shear index of 0.5 or lower. The fluid consistency index, on the other hand, can vary from about 0.1 to about 50 Pa·sⁿ, but is preferably less than about 1 Pa·sⁿ. More preferably, the fluid consistency index is from about 0.20 to about 0.15 Pa·sⁿ. The product preferably has a viscosity from about 0.1 to about 200 Pa s, preferably from about 0.3 to about 20 Pa s as measured with a Brookfield cylinder viscometer (model LVDII) using 10 ml sample, a spindle S-31 and a speed of 3 rpm. Rheology is measured under ambient temperature conditions (25° C.).

Suitable thickening agents for use herein include viscoelastic, thixotropic thickening agents at levels of from about 0.1% to about 10%, preferably from about 0.25% to about 5%, most preferably from about 0.5% to about 3% by weight. Suitable thickening agents include polymers with a molecular weight from about 500,000 to about 10,000,000, more preferably from about 750,000 to about 4,000,000. The preferred cross-linked polycarboxylate polymer is preferably a carboxyvinyl polymer. Such compounds are disclosed in U.S. Pat. No. 2,798,053, issued on Jul. 2, 1957, to Brown. Methods for making carboxyvinyl polymers are also disclosed in Brown. Carboxyvinyl polymers are substantially insoluble in liquid, volatile organic hydrocarbons and are dimensionally stable on exposure to air.

Preferred polyhydric alcohols used to produce carboxyvinyl polymers include polyols selected from the class consisting of oligosaccarides, reduced derivatives thereof in which the carbonyl group is converted to an alcohol group, an pentaerythritol; most preferred is sucrose or pentaerythritol. It is preferred that the hydroxyl groups of the modified polyol be etherified with alkyl groups, the polyol having at least two allyl ether groups per polyol molecule. When the polyol is sucrose, it is preferred that the sucrose have at least about five allyl ether groups per sucrose molecule. It is preferred that the polyether of the polyol comprise from about 0.1% to about 4% of the total monomers, more preferably from about 0.2% to about 2.5%.

Preferred monomeric olefinically unsaturated carboxylic acids for use in producing carboxyvinyl polymers used herein include monomeric, polymerizable, alpha-beta monoolefinically unsaturated lower aliphatic carboxylic acids; more preferred are monomeric monoolefinic acrylic acids of the structure:
CHCH2=C(R)—COOH
where R is a substituent selected from the group consisting of hydrogen and lower alkyl groups; most preferred is acrylic acid.

Various carboxyvinyl polymers, homopolymers and copolymers are commercially available from B. F. Goodrich Company, New York, N.Y., under the trade name Carbopol®. These polymers are also known as carbomers or polyacrylic acids. Carboxyvinyl polymers useful in formulations of the present invention include Carbopol 910 having a molecular weight of about 750,000, Carbopol 941 having a molecular weight of about 1,250,000, and Carbopols 934 and 940 having molecular weights of about 3,000,000 and 4,000,000, respectively. More preferred are the series of Carbopols which use ethyl acetate and cyclohexane in the manufacturing process, Carbopol 981, 2984, 980, and 1382.

Preferred polycarboxylate polymers are non-linear, water-dispersible, polyacrylic acid cross-linked with a polyalkenyl polyether and having a molecular weight of from about 750,000 to about 4,000,000.

Highly preferred examples of these polycarboxylate polymers for use in the present invention are Sokalan PHC-25®, a polyacrylic acid available from BASF Corporation, the Carbopol 600 series resins available from B. F. Goodrich, and more preferred is Polygel DK available from 3-V Chemical Corporation. Mixtures of polycarboxylate polymers as herein described may also be used in the present invention.

Other suitable thickening agents include inorganic clays (e.g. laponites, aluminium silicate, bentonite, fumed silica). The preferred clay thickening agent can be either naturally occurring or synthetic. Preferred synthetic clays include the synthetic smectite-type clay sold under the trademark Laponite by Southern Clay Products, Inc. Particularly useful are gel forming grades such as Laponite RD and sol forming grades such as Laponite RDS. Natural occurring clays include some smectite and attapulgite clays. Mixtures of clays and polymeric thickeners are also suitable for use herein.

Other types of thickeners which can be used in this composition include natural gums, such as xanthan gum, locust bean gum, guar gum, and the like. The cellulosic type thickeners: hydroxyethyl and hydroxymethyl cellulose (ETHOCEL and METHOCEL® available from Dew Chemical) can also be used.

Other Optional Ingredients

Other suitable components herein include an odour-masking perfume or perfume base, organic polymers having dispersant, anti-redeposition, soil release or other detergency properties invention in levels of from about 0.1% to about 30%, preferably from about 0.5% to about 15%, most preferably from about 1% to about 10% by weight of composition. Preferred anti-redeposition polymers herein include acrylic acid containing polymers such as Sokalan PA30®, PA20®, PA15®, PA10® and Sokalan CP10® (BASF GmbH), Acusol 45N®, 480N®, 460N® (Rohm and Haas), acrylic acid/maleic acid copolymers such as Sokalan CP5® and acrylic/methacrylic copolymers. Preferred soil release polymers herein include alkyl and hydroxyalkyl celluloses (U.S. Pat. No. 4,000,093), polyoxyethylenes, polyoxypropylenes and copolymers thereof, and nonionic and anionic polymers based on terephthalate esters of ethylene glycol, propylene glycol and mixtures thereof.

Heavy metal sequestrants and crystal growth inhibitors are suitable for use herein in levels generally from about 0.005% to about 20%, preferably from about 0.1% to about 10%, more preferably from about 0.25% to about 7.5% and most preferably from about 0.5% to about 5% by weight of composition, for example diethylenetriamine penta (methylene phosphonate), ethylenediamine tetra(methylene phosphonate) hexamethylenediamine tetra(methylene phosphonate), ethylene diphosphonate, hydroxy-ethylene-1,1-diphosphonate, nitrilotriacetate, ethylenediaminotetracetate, ethylenediamine-N,N′-disuccinate in their salt and free acid forms.

The compositions herein can contain a corrosion inhibitor such as organic silver coating agents in levels of from about 0.05% to about 10%, preferably from about 0.1% to about 5% by weight of composition (especially paraffins such as Winog 70 sold by Wintershall, Salzbergen, Germany), nitrogen-containing corrosion inhibitor compounds (for example benzotriazole and benzimidazole—see GB-A-1137741) and Mn(II) compounds, particularly Mn(II) salts of organic ligands in levels of from about 0.005% to about 5%, preferably from about 0.01% to about 1%, more preferably from about 0.02% to about 0.4% by weight of the composition.

Other suitable components herein include colorants, water-soluble bismuth compounds such as bismuth acetate and bismuth citrate at levels of from about 0.01% to about 5%, enzyme stabilizers such as calcium ion, boric acid, propylene glycol and chlorine bleach scavengers at levels of from about 0.01% to about 6%, lime soap dispersants (see WO-A-93/08877), suds suppressors (see WO-93/08876 and EP-A-0705324), polymeric dye transfer inhibiting agents, optical brighteners, perfumes, fillers and clay.

Liquid detergent compositions can contain water and other volatile solvents as carriers. Low quantities of low molecular weight primary or secondary alcohols such as methanol, ethanol, propanol and isopropanol can be used in the liquid detergent of the present invention. Other suitable carrier solvents used in low quantities includes glycerol, propylene glycol, ethylene glycol, 1,2-propanediol, sorbitol and mixtures thereof.

Process of Cleaning a Hard Surface

The compositions of the present invention are especially useful in direct application for pre-treatment of cookware or tableware soiled with cooked-, baked- or burnt-on residues (or any other highly dehydrated soils). The compositions are preferably applied to the soiled substrates in the form for example of a spray or foam prior to automatic dishwashing, manual dishwashing, rinsing or wiping. The pre-treated cookware or tableware can feel very slippery and as a consequence difficult to handle during and after the rinsing process. This can be overcome using divalent cations such as magnesium and calcium salts, especially suitable for use herein is magnesium chloride. The addition of from about 0.01% to about 5%, preferably from about 0.1% to about 3% and more preferably from about 0.4% to about 2% (by weight) of magnesium salts eliminates the slippery properties of the cookware or tableware surface without negatively impacting the stability of physical properties of the pre-treatment composition. The compositions of the invention can also be used as automatic dishwashing detergent compositions or as a component thereof.

In a method aspect, the invention provides a method of removing cooked-, baked- or burnt-on soils from cookware and tableware comprising treating the cookware/tableware with the composition of the invention. Preferred methods comprise the step of pre-treating the cookware/tableware with the composition of the invention prior to manual or automatic dishwashing. If desired the process of removing of cooked-, burnt- and baked-on soils can be facilitated if the soiled substrate is covered with cling film after the cleaning composition of the invention has been applied in order to allow swelling of the soil to take place. Preferably, the cling film is left in place for a period of about 1 hour or more, preferably for about 6 hours or more.

There is also provided a hand dishwashing product comprising the composition of the invention and a spray dispenser. The physical properties of the composition and the geometrical characteristic of the spray dispenser in combination are preferably such as to provide spray droplets with an average equivalent geometric diameter from about 3 μm to about 10 μm, preferably from about 4 μm to about 7 μm, as measured using a TSI Aerosizer®, such droplet size range being optimum from the viewpoint of odour impression and reduced malodour characteristics. Suitable spray dispensers include hand pump (sometimes referred to as “trigger”) devices, pressurized can devices, electrostatic spray devices, etc.

### EXAMPLES

The following examples will further illustrate the present invention. The compositions are made by combining the listed ingredients in the listed proportions (weight % unless otherwise specified). Example 1, 2 and 3 are meant to exemplify compositions according to the present invention, but are not necessarily used to limit or otherwise define the scope of the present invention. Examples A and B are comparative examples. Composition A is a high pH formulation and Example B is a nil-enzyme comparison of example 1

| Components | Example A | Example 1 | Example B | Example 2 | Example 3 |
|---|---|---|---|---|---|
| Surfactants | | | | | |
| Amine Oxide | 2% | — | — | — | — |
| Alkyl Polyglycoside | — | 10% | 10% | — | — |
| C11E8 Nonionic | — | — | — | 10% | 5% |
| C12-14 Alkyl sulfate | | — | — | — | 3% |
| C12-14 Fatty Acid | | 5% | 5% | 2% | 2% |
| Solvents | | | | | |
| DPnB | 5% | — | — | — | — |
| EPh | 5% | — | — | — | — |
| n-Butyl Alcohol | — | 7% | 7% | — | — |
| Ethanol | — | — | — | 5% | 3% |
| C8-10 Methyl Ester | — | 25% | 25% | 25% | 25% |
| Monoethanolamine | 5% | 1.5% | 1.5% | 2% | 2% |
| Enzyme | | | | | |
| Amylase | 0.02% | 0.02% | — | 0.02% | 0.02% |
| Protease | 0.02% | 0.02% | — | 0.02% | 0.02% |
| Others | | | | | |
| Na Carbonate | 2% | — | — | — | — |
| Na Cumene sulfonate | 4% | — | — | 3% | 3% |
| pH of 10% solution | 12 | 9 | 9 | 9 | 9 |
| Stability | | | | | |
| % Enzyme Remaining | 0% | 60% | — | 60% | 60% |
| after 2 weeks ambient | | | | | |
| Performance | | | | | |
| % Protein Soil Removal | | | | | |
| 15 minutes | 0% | 30% | 10% | 10% | 10% |
| 30 minutes | 10% | 90% | 60% | 60% | 60% |
| % Polymerized Grease | | | | | |
| 15 minutes | 30% | 50% | 50% | 50% | 50% |
| 30 minutes | 45% | 90% | 90% | 90% | 90% |

Grease Soiling Method

The present method involves cleaning of soiled coupons. By the term coupon we mean standard stainless steel substrates 3 inch by 1.5 inch in size. The coupons are first cleaned in distilled water and ethanol and once dried are treated with the soil in question. Preferably the soil is painted onto the coupon with a paintbrush in order to homogeneously and consistently treat the coupon with the soil. The coupons are then baked for 20 minutes at 475 F. The grease soil is PAM original canola spray. The coupons are weighed once they are cleaned and after treatment with the soil. Amount of soil on the coupon should be in the range of from 0.008 to 0.024 g.

Protein Soiling Method

The coupons are cleaned and prepared with soil in the same method as described above. The soil here however is egg yolk.

Cleaning Test

The test substrates, the soiled coupons as discussed above are re-weighed prior to use in this test.

3 ml of the cleaning compositions as detailed above were dosed onto the soiled coupons and allowed to sit for either 15 minutes or 30 minutes (mimicking in home use conditions). Following the treatment, each coupon was wiped 20 strokes with a paper towel, rinsed under running tap water, and set aside to dry (12 hours). After drying overnight (to remove residual water that would interfere with soil removal determination) each coupon was re-weighed and the % soil removal calculated.

The disclosure of all patents, patent applications (and any patents which issue thereon, as well as any corresponding published foreign patent applications), and publications mentioned throughout this description are hereby incorporated by reference herein. It is expressly not admitted, however, that any of the documents incorporated by reference herein teach or disclose the present invention.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

While particular embodiments of the subject invention have been described, it will be obvious to those skilled in the art that various changes and modifications of the subject invention can be made without departing from the spirit and scope of the invention. In addition, while the present invention has been described in connection with certain specific embodiments thereof, it is to be understood that this is by way of illustration and not by way of limitation and the scope of the invention is defined solely by the appended claims which should be construed as broadly as the prior art will permit.

What is claimed is:

1. A composition suitable for cleaning cooked-, baked- and burnt-on soils having pH of a 10% solution thereof of from 6 to 10 and comprising a surface modifying agent selected from the group consisting of alkyl esters having the formula RCOOR₁, wherein the R group is selected from the group consisting of C1-C6 alkyl and the R₁ group is selected from the group consisting of C4-C40 fatty acid a soil swelling agent and an enzyme.

2. A composition according to claim 1 that is formulated as a microemulsion.

3. A composition according to according to claim 1 wherein the pH of a 10% solution of the composition is from 8 to 9.5.

4. A composition according to claim 1 wherein the surface modifying agent is selected from the group consisting of methyl, ethyl, propyl esters of C4-C40 fatty acids and mixtures thereof.

5. A composition according to claim 1 wherein the soil modifying agent is present at a level of 1% to 50%.

6. A composition according to claim 1 wherein the soil swelling agent is monoethanolamine.

7. A composition according to claim 1 wherein the soil swelling agent is present at a level of from 0.1 to 10%.

8. A composition according to claim 1 wherein the enzyme is selected from the group consisting of cellulases, hemicellulases, peroxidases, proteases, gluco-amylases, amylases, lipases, cutinases, pectinases, xylanases, reductases, oxidases, phenoloxidases, lipoxygenases, ligninases, pullulanases, tannases, pentosanases, malanases, β-glucanases, arabinosidases or mixtures thereof, more preferably amylases, proteases and mixtures thereof.

9. A method of removing cooked-, baked- or burnt-on soils from cookware and tableware comprising treating the cookware/tableware with a composition according to claim 1.

10. A method according to claim 9 comprising the step of pre-treating the cookware/tableware with the composition prior to manual or automatic dishwashing.

11. A method according to either of claim 9 comprising the step of spraying said hard surface cleaning composition onto parts of said cookware and tableware.

12. A hand dishwashing product comprising the composition according to claim 1 and a spray dispenser therefore.

13. The hand dishwashing product of claim 12 wherein the spray dispenser provides a spray having spray droplets that have an average equivalent geometric diameter from about 3 μm to about 10 μm as measured using a TSI Aerosizer.
